(19) United States
(12) Patent Application Publication
(10) Pub. No.: US 2017/0299980 A1
(43) Pub. Date: Oct. 19, 2017

(54) SELENIUM DRUM CAPABLE OF CONTINUOUSLY SUPPLYING POWDER AND IMAGE FORMING DEVICE

(71) Applicant: Chin-Lung Han, Taiwan (CN)

(72) Inventor: Chin-Lung Han, Taiwan (CN)

(21) Appl. No.: 15/513,234

(22) PCT Filed: Aug. 31, 2015
(86) PCT No.: PCT/CN2015/000620

§ 371 Date: Mar. 22, 2017

(30) Foreign Application Priority Data
Sep. 29, 2014 (CN) 201420567711.2

(51) Int. Cl. G03G 15/08; G03G 15/01

(52) U.S. Cl. CPC G03G 15/0834; G03G 15/0832; G03G 15/0142

(57) ABSTRACT

A selenium drum capable of continuously supplying powder, comprising a photosensitive drum, a cleaning scraper, a carbon powder bin and a waste powder bin, and further comprising a carbon powder storage bin and a waste powder storage bin; a first isolating mechanism is arranged between the carbon powder storage bin and the carbon powder bin, and a second isolating mechanism is arranged between the waste powder storage bin and the waste powder bin. Also provided is an image forming device having the selenium drum capable of continuously supplying powder. The selenium drum capable of continuously supplying powder and the image forming device having the same enable a user to drive a cleaning of the waste powder bin via gravity or hands when filling with carbon powder.

### TECHNICAL FIELD

The present invention relates to a technical field of an electrophotographic apparatus, more particularly, to a cartridge (a toner hopper/a toner cassette, or a cassette) used in an image forming device by means of electrophotography, such as a printer and a copying machine.

### BACKGROUND

Generally speaking, a printer cartridge is composed of major components such as a toner hopper, a waste hopper, a photoconductive component, a primary charging roller (PCR), a magnetic roller, a doctor blade, and a wiper blade. The major components form a cartridge by a combination, and are assembled inside the printer for developing images. According to a position of the laser light source relative to the photoconductive (OPC) drum, a cartridge can be divided into a horizontal exposure type and a vertical exposure type. Therefore, a shape design of the cartridge is also divided into two types: an n-shaped type (like a Chinese character “ [symbol] ”) and a two-wing-shaped type. A laser source of the n-shaped cartridge is exposed horizontally through the middle of the n-shaped area. A laser source of the two-wing-shaped cartridge is vertically exposed downwards through a part between an upper wing and a lower wing of the two-wing-shaped cartridge.

Existing cartridges, such as those provided by major manufacturers such as HP, Canon, and Samsung, are all designed to be disposable. That is to say, after toners originally loaded in the cartridge are exhausted, the cartridge is directly discarded, therefore, it is necessary for the user to re-purchase a new cartridge. However, although the toners are used up, most other parts of the cartridge can still be used, especially the photoconductive components (such as photoconductive drum). A direct discard causes waste of resources, as well as environmental pollution.

In the industry, some companies recycle discarded cartridges by refilling toners, and then sell the refilled cartridges, so as to realize a compatible recycle and reuse. In general, a cartridge can be repeatedly recycled for 3-4 times by refilling. It is difficult for an average user to complete disassembly and assembly of cartridges (also known as cassette, toner hopper, etc.), because disassembly process and assembly process are complicated. Therefore, a hole for replenishing toners is designed in the toner hopper, and a hole for cleaning up wastes is designed in the waste hopper, so as to facilitate recycling companies to re-fill toners, or to facilitate users to fill toners by themselves. However, such toner refilling and cleaning modes are still inconvenient for users. For instance, toners might be spattered or be absorbed by human body. As a result, both the environment and users' bodies will be damaged.

This problem can be alleviated when most parts of the cartridge reach the service life at the same time. The design of the cartridge is further studied in the industry. Some put forward a design concept of continuous supply toner cartridge. For example, Chinese Patent No. 201220475087.4 proposes a manually filled toner cartridge having one or more identical toner storage bins (vertically stacked) connected to the toner hopper. And a toner filling valve is provided at the bottom of each toner storage bin. According to a metering and detecting device detects consumption of the toner, the user will be reminded to manually open the valve by means of a light signal so as to rapidly fill toners, when it is necessary for the users to fill toners. For another example, Chinese Patent of No. 201220477766.5 puts forward a manually filling toner hopper. One or more identical toner storage bins (vertically stacked) are connected to the toner hopper. And the toner storage bins are connected to the toner hopper. A toner filling valve is provided at the bottom of each toner storage bin. According to a consumption of toners, a metering and detecting device can be used to detect whether it is necessary to fill toners, and to open the toner filling valves, so as to realize automatically refilling. For another example, Chinese Patent of No. 201320642919.1 puts forward a printer toner capacity expansion device, which comprises an expansion bin, a toner hopper and a cartridge seal Mylar. The expansion bin is connected to the toner hopper through a chute opening. And the expansion bin is vertically arranged above the toner hopper. Toners inside the expansion bin are sealed with the cartridge seal Mylar, so as to increase the toner capacity.

However, the above-mentioned three designs such as automatically filling toner bins (vertically stacked), manually filling toner bins (vertically stacked), or multiple toner capacity expansion bins vertically arranged above the toner hopper, are all conceptual designs. Make a general view at these three solutions, it can be found that: multiple expansion bins for toner hoppers have been designed in the three solutions, however, corresponding expansion bins for waste hoppers have not been designed in the three solutions. In addition, the structure and the capacity of the waste hopper in existing cartridges in the current market cannot meet the requirement to recycle wastes in a continuous toner supplying cartridge. (The existing waste hopper is designed to be located inside the outer cover, so its capacity has to be miniaturized.) It is evidently difficult to satisfy the demand for waste collection. Moreover, parallel arranged designs or vertically stacking designs lead to a new problem, that is, larger internal space of a printer is necessary to solve new problem. Therefore, it is necessary to modify the whole structure of the printer. And for the users, it is not expected to purchase a new machine with an additional cost.

### SUMMARY OF THE INVENTION

In view of the defects or deficiencies of the prior art, an object of the present invention aims to provide a novel continuous toner supplying cartridge, base on premises of saving costs and collecting wastes conveniently, under a precondition not to modify the original design of the printer. The present invention proposes a novel continuous toner supplying cartridge, which can make full use of the guiding space inside the printer used for placing the cartridge, for storage of toners to be continuously supplied to the cartridge, and for convenience and effects to recover wastes.

Another object of the present invention aims to provide an image forming device, which comprises the above continuous toner supplying cartridge.

Above objects of the present invention are achieved by the technical features of the independent claims. The dependent claims develop the technical features of the independent claims in an alternative or advantageous manner.

In order to achieve the above objects, the technical solution adopted by the present invention is as follows:

A continuous toner supplying cartridge, comprising a photoconductor (OPC) drum, a wiper blade, a toner hopper and a waste hopper, wherein, the continuous toner supplying cartridge further comprising:

A toner storage bin, wherein, a first isolation mechanism is provided between the toner storage bin and the toner hopper; and,

A waste storage bin, wherein, a second isolation mechanism is provided between the waste storage bin and the waste hopper.

In a further embodiment, the second isolation mechanism is movable between a first position in which the waste storage bin is connected with the waste hopper, and a second position in which the waste storage bin is isolated from the waste hopper.

In a further embodiment, the second isolation mechanism is configured as a one-way opening valve which can be opened under an external drive or a gravity action.

In a further embodiment, a waste guiding mechanism is provided in the toner hopper for guiding waste toners in the waste hopper into the waste storage bin. For example, a belt type guide mechanism, or a blade type guiding mechanism may be used.

In a further embodiment, the photoconductor drum is configured as the waste guiding mechanism.

In a further embodiment, a connection port between the waste storage bin and the waste hopper is higher than an edge of the wiper blade.

In a further embodiment, the waste guiding mechanism is configured higher than an edge of the wiper blade, so that the waste toners can be guided to a position higher than the edge of the wiper blade.

In a further embodiment, the waste guiding mechanism is configured as a belt type guide mechanism, or a blade type guiding mechanism.

In a further embodiment, the continuous toner supplying cartridge comprises at least two waste storage bins, and, an isolation mechanism, which can be one-way opened, is provided between the at least two waste storage bins. The isolation mechanism is configured as a one-way valve, a plastic sheet or a metal sheet.

In a further embodiment, the first isolation mechanism provided between the toner storage bin and the toner hopper is movable between a first position in which the toner storage bin is isolated from the toner hopper, and a second position in which the toner storage bin is connected with the toner hopper.

In a further embodiment, the first isolation mechanism is configured as a switch valve, a seal Mylar, or other isolation mechanisms that can be opened by being actuated from external.

In a further embodiment, a position inside the toner storage bin, which is adjacent to a connection port between the toner storage bin and the toner hopper, is configured as a reverse taper structure or a reverse trapezoidal structure. By opening the first isolation mechanism disposed in the connection port, toners in the toner storage bin are automatically guided into the toner hopper under gravity action.

In a further embodiment, the continuous toner supplying cartridge is configured as an n-shaped structure (like a Chinese character “ [symbol] ”), and a connection port between the toner storage bin and the toner hopper is located in such a position that:

The connection port is located above and behind the n-shaped cartridge along a direction in which the cartridge is loaded into a printer, at two outer sides of an included angle from both ends of a print width position, which is limited by the n-shaped cartridge, to a printer laser source of the printer.

In a further embodiment, the continuous toner supplying cartridge is configured as an n-shaped structure, and an available space for the toner storage bin is located in such a position that:

A perpendicular line, which is from the photoconductor drum, is vertical to a printer laser source beam; and then a point is obtained by moving toward the printer laser source by 45 cm from the photoconductor drum along the printer laser source beam; An upward line is drawn from the point to form an included angle of 60 degrees from the printer laser source beam; a forward-backward available space of the toner storage bin is a position limited by an overall width of 90 cm, wherein, a left translation is made by 45 cm from the upward line, and a right translation is made by 45 cm from the upward line; and a left-right available space of the toner storage bin is an overall width of the cartridge; wherein, a horizontal line formed by the printer laser source and the photoconductor drum is set as a reference line.

In a further embodiment, the continuous toner supplying cartridge is configured as a two-wing-shaped structure, and a connection port between the toner storage bin and the toner hopper is located in such a position that:

The connection port is located above and behind the two-wing-shaped cartridge along a direction in which the cartridge is loaded into the printer.

In a further embodiment, the continuous toner supplying cartridge is configured as a two-wing-shaped structure, and an available space for the toner storage bin is located in such a position that:

A perpendicular line, which is from a central point set as a mixer shaft of the toner hopper, is vertical to a laser source beam; an upward line is drawn to form an included angle of 45 degrees from the perpendicular line; a forward-backward available space of the toner storage bin is a position limited by an overall width of 90 cm; wherein, a left translation is made by 45 cm from the upward line and a right translation is made by 45 cm from the upward line; and a left-right available space of the toner storage bin is an overall width of the cartridge.

In a further embodiment, the continuous toner supplying cartridge comprises at least two waste storage bins, and a third isolation mechanism is provided between the at least two waste storage bins.

In a further embodiment, along the direction of loading the cartridge into the printer, the toner storage bins are combined with the cartridge so as to form a stack in an odd shape.

In a further embodiment, a toner filling port is provided in the toner storage bin.

In a further embodiment, a handle is further provided in the toner storage bin.

According to another aspect of the present invention, an image forming device is put forward. The image forming device comprises any of the above continuous toner supplying cartridges.

The continuous toner supplying cartridge proposed in the present invention, and the image forming device comprising this continuous toner supplying cartridge, can alleviate waste of resources and environmental pollution caused by existing cartridges (also known as cassettes, and toner cartridges) which will be directly discarded after being used only once. Meanwhile, the waste storage bins are designed according to a combination of the toner hopper and the toner storage bins. Therefore, the waste hopper can be cleaned by the users, when users add toners. The present invention will extend a useful life of cartridges and reduce printing costs.

### DESCRIPTION OF THE DRAWINGS

FIG. 1 illustrates an overall schematic view an embodiment of a continuous toner supplying cartridge disclosed in the present invention. The continuous toner supplying cartridge of this embodiment has an n-shaped structure (like a Chinese character “ [symbol] ”).

FIG. 2 illustrates a structural view showing the structure of the continuous toner supplying cartridge according to the embodiment of FIG. 1.

FIG. 3 illustrates a schematic view of an exemplary embodiment of a waste guiding mechanism, i.e., a belt guiding mechanism.

FIG. 4 illustrates a schematic view of another exemplary embodiment of a waste guiding mechanism, i.e., a blade guiding mechanism.

FIG. 5 illustrates a structural view of the continuous toner supplying cartridge as claimed in another embodiment of the present invention. The continuous toner supplying cartridge of this embodiment has a two-wing-shaped structure.

### DETAILED DESCRIPTION OF THE EMBODIMENTS

In order to better understand the technical contents of the present invention, in combination with accompanying drawings, specific embodiments are described in detail as follows.

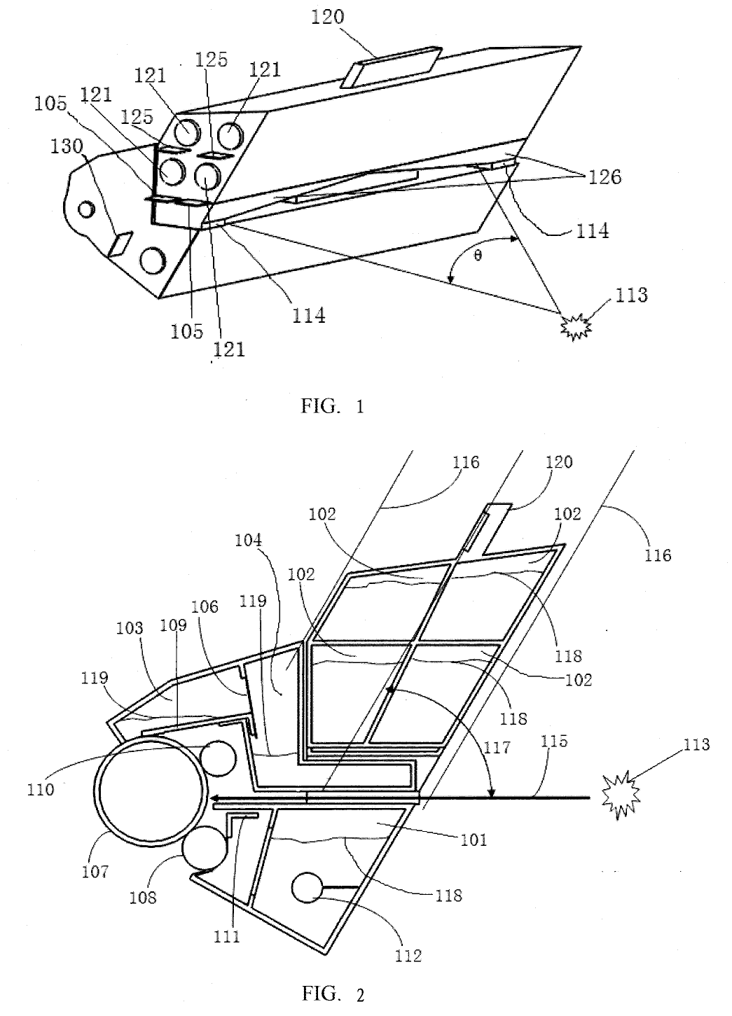

A continuous toner supplying cartridge 100 shown in FIG. 1 and FIG. 2 is configured as an n-shaped structure (like a Chinese character “ [symbol] ”). A continuous toner supplying cartridge 100, comprising a toner hopper 101, toner storage bins 102, a waste hopper 103, a waste storage bin 104. Wherein, a first isolation mechanism 105 is provided between the toner storage bin 102 and the toner hopper 101; and, a second isolation mechanism 106 is provided between the waste storage bin 104 and the waste hopper 103.

By using the continuous toner supplying cartridge 100 in the n-shaped structure, multiple toner storage bins and multiple waste storage bins are combined in a single toner cartridge. Because a number of toner containers in the present invention is one or more times greater than a number of toner containers in the prior art, the capacity of toners in the present invention is one or more times larger than the capacity of toners in the prior art. Because a number of waste containers in the present invention is one or more times greater than a number of toner containers in the prior art, the capacity of wastes in the present invention is one or more times larger than the capacity of wastes in the prior art. Toners can be added manually or automatically by being replenished. Waste toners can be removed manually or automatically by being cleaned up. Such an improvement will lead to several times of printing amounts, fully utilize resources, and save users' usage costs.

The continuous toner supplying cartridge 100 can significantly alleviate waste of resources and environmental pollution caused by existing cartridge which will be directly discarded after being used only once. Meanwhile, the waste storage bins are designed according to a combination of the toner hopper and the toner storage bins. Therefore, the waste hopper can be cleaned by the users, when users add toners. The present invention will extend a useful life of cartridges and reduce printing costs.

As shown in FIG. 1 and FIG. 2, it can be seen that the continuous toner supplying cartridge 100 comprises a photoconductive (OPC) drum 107, a magnetic roller 108, a wiper blade 109, a primary charging roller (PCR) 110, a doctor blade 111, a toner mixer 112, and an isolating mechanism 130. This isolating mechanism 130 is used to open the toner hopper 101 when the cartridge 100 is used for the first time. The functions, roles, effects and connection ways of these parts or components are well known to those skilled in the art, therefore, the details related to these issues are unnecessary to be given here.

The toner hopper 101, the toner storage bins 102, and the waste hopper 103 and the waste storage bin 104 are all surrounding the photoconductive (OPC) drum 107.

As shown in FIG. 2, an approximate position of a printer laser source 113 corresponding to the n-shaped continuous toner supplying cartridge 100 is also marked out in FIG. 2. As above mentioned, the laser source 113 is exposed horizontally through the middle of the n-shaped area.

According to FIG. 1, the continuous toner supplying cartridge 100 is configured as an n-shaped structure (like a Chinese character “ [symbol] ”), and a connection port 114 between the toner storage bins 102 and the toner hopper 101 is located in such a position that:

The connection port is located above and behind the n-shaped cartridge 100 along a direction in which the cartridge is loaded into a printer, at two outer sides of an included angle θ from both ends of a print width position, which is limited by the cartridge 100 of the printer, to a printer laser source 113 of the printer.

Furthermore, according to FIG. 1 and FIG. 2, the continuous toner supplying cartridge 100 is configured as an n-shaped structure, and it is preferable that an available space for the toner storage bins 102 is located in such a position that:

A perpendicular line, which is from the photoconductor (OPC) drum 107, is vertical to a printer laser source beam 115; and then a point is obtained by moving toward the printer laser source 113 by 45 cm from the photoconductor drum 107 along the printer laser source beam 115; An upward line is drawn from the point to form an included angle of 60 degrees from the printer laser source beam 113; a forward-backward available space of the toner storage bins 102 is a position limited by an overall width of 90 cm, wherein, a left translation is made by 45 cm from the upward line, and a right translation is made by 45 cm from the upward line; and a left-right available space of the toner storage bins 102 is an overall width of the cartridge; wherein, a horizontal line formed by the printer laser source 113 and the photoconductor drum 107 is set as a reference line.

As shown in FIG. 2, reference signs 116 denote a pair of translation lines at an interval of 90 cm, which is the width of the toner storage bins 102.

In FIG. 2, a reference sign 117 denotes the inclination angle of the toner storage bins 102, and it uses the horizontal level formed by the printer laser source 113 and the photoconductive drum 107 as a reference line. The value a of the inclination angle of the toner storage bins 102 is in a certain range between 0 degree and 85 degrees, i.e. [0°, 85°].

In FIG. 2, a reference sign 118 means toners, and a reference sign 119 represents waste toners.

As shown in FIG. 2, the first isolation mechanism 105 provided between the toner storage bins 102 and the toner hopper 101 is movable between a first position in which the toner storage bins 102 is isolated from the toner hopper 101 by the first isolation mechanism 105, and a second position in which the toner storage bins 102 is connected with the toner hopper 101 by the first isolation mechanism 105.

The first isolation mechanism 105 is an openable isolating mechanism.

In a preferred embodiment, the first isolation mechanism 105 is configured as a switch valve, a seal Mylar, or other isolation mechanisms that can be opened by being actuated from external. Of course, this paragraph is not a limitation.

As shown in FIG. 1, a handle 120 can be preferably provided on the toner storage bin 102 to facilitate the user to replace the entire cartridge 100. The handle 120 is mounted as a protuberant part or formed on the outer surface of the toner storage bin 102.

As shown in FIG. 1, a toner filling port 121 can be preferably provided on the toner storage bin 102 so as to facilitate the user to manually or automatically fill the toner storage bin in a traditional manner for considerations such as cost saving.

In an alternative embodiment, the cartridge 100 includes at least two toner storage bins 102 (four stacked toner storage bins 102 are provided in an embodiment shown in FIG. 2), and a third isolation mechanism 125 is provided between the at least two waste storage bins 102. The third isolation mechanism 125, which may employ a same configuration as the first isolation mechanism, is configured as a switch valve, a seal Mylar, or other isolation mechanisms that can be opened by being actuated from external.

In some embodiments, the toner storage bin(s) 102 is/are assembled on the toner cartridge 100 so as to form an odd shape, along a direction of loading the cartridge 100 into the printer. Wherein the odd shape means that: the way of stacking toner storage bins 102 into the toner cartridge can be freely designed, by taking consideration of the internal space of the printer, in particular to the internal space along the direction of loading the cartridge into the printer (or other image forming devices such as a copying machine). Of course, in case of need, or allowed by the internal space of the printer with some models, a horizontal arrangement or a vertical arrangement can also be made.

As an alternative solution, a position inside the toner storage bin 102, which is adjacent to a connection port 104 between the toner storage bin 102 and the toner hopper 101, is configured as a reverse taper structure or a reverse trapezoidal structure so as to fully guide toners into the toner hopper 101.

As shown in FIG. 1, as a preferable embodiment, a guiding groove 126 is provided between the toner storage bin(s) 102 and the connection port 104, so that the toner storage bin(s) 102, which is/are tilted or inclined under a gravity action of toners in the toner storage bin(s) 102, can be guided and slipped smoothly into the connection port 114, so as to be guided into the toner hopper 101. The guiding groove 126 is connected with the inner space of the toner storage bin(s) 102, and the guiding groove 126 is connected with the connection port 104.

As shown in FIG. 1 and FIG. 2, within the range of the aforementioned available space, the toner storage bin 102 covers various geometrical shapes such as: a square, a rectangle and a circle.

As shown in FIG. 1, the aforementioned the second isolation mechanism is movable 106 between a first position in which the waste storage bin 104 is connected with the waste hopper 103, and a second position in which the waste storage bin 104 is isolated from the waste hopper 103.

The second isolation mechanism 106 is configured as a one-way opening valve which can be opened under an external drive or a gravity action. For instance, a one-way valve driven by an external rotation, or a plastic sheet or a metal sheet, can be provided. Besides, a rotatable separation blade inclining toward the waste hopper 103 can be adopted.

When it is necessary to be guide waste toners in the waste hopper 103 into the waste storage bin 104, the second isolation mechanism can be manually opened from outside, or the whole cartridge 100 can be manually rotated upward by 90 degrees, so as to connect the waste storage bin 104 to the waste hopper 103, and to dump the wastes into the waste storage bin 104 under an automatic guidance of a gravity action.

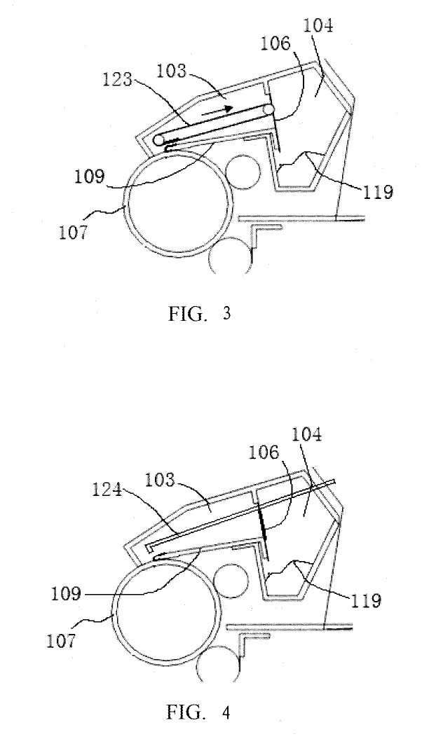

In some other embodiments, as shown in FIG. 3 and FIG. 4, waste guiding mechanisms 123, 124 can be set in the toner hopper 103, for guiding waste toners in the toner hopper 103 into the waste storage bin 104.

The waste guiding mechanism is configured higher than an edge of the wiper blade 109, so that the waste toners can be guided to a position higher than the edge of the wiper blade 109, therefore, the waste toners are guided conveniently. In another word, The connection port between the waste storage bin 104 and the waste hopper 103 is higher than the edge of the wiper blade.

FIG. 3 and FIG. 4 illustrate structure diagrams for the waste guiding mechanisms.

As shown in FIG. 3, the reference sign 123 means a belt type guide mechanism which comprises two delivery wheels and a belt surrounding the delivery wheels. The delivery wheels can be driven to rotate by manually rotating a rotary knob provided on the outer surface of the cartridge 100, so as to guide waste toners into the waste storage bin 104.

As illustrated in FIG. 4, the reference sign 124 means a blade type guide mechanism which comprises at least one blade. The end(s) of the blade(s) is/are bent near the photoconductor (OPC) drum, so that the blade(s) is/are formed as a L-shaped structure. This blade(s) can be pulled from outside, and the bending at the end(s) can be utilized to guide the waste toners into the waste storage bin 104.

In other embodiments, the above-mentioned photoconductor (OPC) drum 107 is configured as the above waste guiding mechanism. At this time, users can manually rotate the cartridge 100 upward by 90 degrees. A thrust generated by the rotation of photoconductor (OPC) drum can pass above the blade and automatically guide waste toners in the toner hopper into the stated waste storage bin.

In further embodiments, it is particularly preferable that the continuous toner supplying cartridge 100 comprises at least two waste storage bins 104, and a one-way isolation mechanism, which can be one-way opened, is provided between the at least two waste storage bins 104. The isolation mechanism is configured such as a one-way valve, a plastic sheet or a metal sheet, to prevent a reverse flow of wastes.

According to FIG. 1 and FIG. 2, in the process of using this continuous toner supplying cartridge 100, when toners in the toner hopper 101 are used up or nearly used up, users can open the above-mentioned first isolation mechanism 105, to automatically guide toners in the toner storage bin 102 into the toner hopper 101 under a gravity action. Hence toners can be continuously supplied. As shown in FIG. 1, as a preferable embodiment, the guide groove 126 can guide toners more smoothly.

As above described, in the structure of continuous toner supplying cartridge 100 with at least two toner storage bins 102, when toners in the toner hopper 101 are used up or nearly used up, users can open the first isolation mechanism 105, to automatically guide toners in the first toner storage bin into the toner hopper 101 under a gravity action. Hence toners can be automatically refilled and continuously supplied. Moreover, when toners in the first toner storage bin are used up or nearly used up, users can open the third isolation mechanism between the toner storage bins, so as to automatically guide toners in the second toner storage bin into the toner hopper 101 (by passing the first toner storage bin) under a gravity action. Hence toners are automatically refilled for the second time. The rest can be done in the same manner. In the continuous toner supplying cartridge 100 with more toner storage bins 102, continuous supply of toners can be realized in the same mode.

According to FIG. 1 and FIG. 2, in the process of using this continuous toner supplying cartridge 100, when it is necessary to clean up wastes (for instance, if waste toners accumulated in the waste hopper 103 should be cleaned up, before toners in the toner storage bin 102 is filled to the toner hopper 101), users can rotate the cartridge upward by 90 degrees, so as to automatically guide waste toners in the waste hopper 103 into the waste storage bin 104 under gravity action. Besides, a manual mode of external drive (such as the previously mentioned waste guiding mechanisms 123, 124 or a rotation thrust of the photoconductor (OPC) drum 107) can be adopted, so as to guide waste toners into the waste storage bin 104 and to clean up the waste hopper 103.

As above described, in the structure of continuous toner supplying cartridge 100 with at least two waste storage bins 104, a one-way isolation mechanism is used such as a one-way valve, a plastic sheet or a metal sheet so as to prevent wastes from reversely flowing. In addition, for instance, the cartridge is rotated upward by 90 degrees. Therefore, the wastes can be further guided into an empty waste storage bin, so as to clean up the waste hopper 103, and to fulfill the requirement of toner recycling under a printing task of continuously supplying toners. Therefore, when toners are automatically refilled from the toner storage bin into the toner hopper, it is not necessary to dump out waste toners. The waste hopper can be cleaned up by directly flipping or simply manually rotating. It is easy to operate. Moreover, the wastes will not be spilled, the environment would not be influenced, and human body would not be damaged.

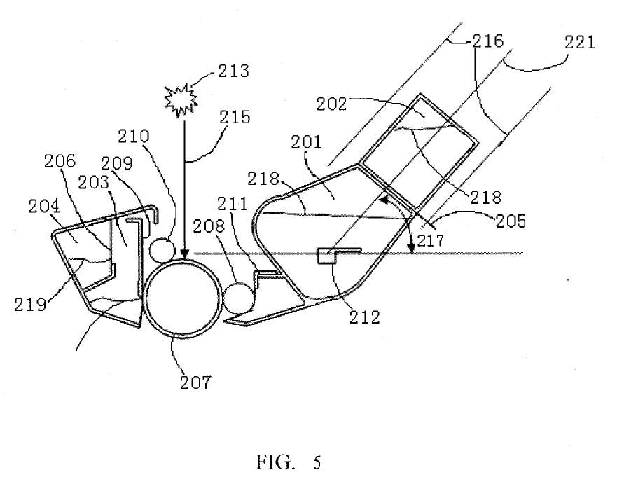

FIG. 5 is a structure diagram for another embodiment about the continuous toner supplying cartridge according to present invention. And the continuous toner supplying cartridge in this embodiment has a two-wing-shaped structure. As shown in the FIG. 5, this two-wing-shaped continuous toner supplying cartridge 200 comprises a toner hopper 201, a toner storage bin 202, a waste hopper 203 and a waste storage bin 204. Wherein, a first isolation mechanism 205 is provided between the toner storage bin 202 and the toner hopper 201; a second isolation mechanism 206 is provided between the waste storage bin 204 and the waste hopper 203.

The two-wing-shaped continuous toner supplying cartridge 200 further comprises a photoconductor (OPC) drum 207, a magnetic roller 208, a wiper blade 209, a primary charging roller (PCR) 210, a doctor blade 211, and a toner mixer 212. The functions, roles, effects and connection ways of these parts or components are well known to those skilled in the art, therefore, the details related to these issues are unnecessary to be given here.

The toner hopper 201, the toner storage bin 202, the waste hopper 203 and the waste storage bin 204 are all surrounding the photoconductor (OPC) drum 207.

As shown in FIG. 5, an approximate position of printer laser source 213 corresponding to the two-wing-shaped continuous toner supplying cartridge 200 is also marked out. As above described, the laser source 213 of the two-wing cartridge is vertically exposed downwards through a part between an upper wing and a lower wing the two-wing cartridge.

According to FIG. 5, the continuous toner supplying cartridge 200 is configured as a two-wing-shaped structure, and a connection port between the toner storage bin 202 and the toner hopper 201 is located in such a position that:

The connection port is located above and behind the two-wing-shaped cartridge 200 along a direction in which the cartridge is loaded into the printer.

Further, as can be seen from FIG. 5, the continuous toner supplying cartridge 200 is configured as a two-wing-shaped structure, and an available space for the toner storage bin 202 is located in such a position that:

A perpendicular line, which is from a central point set as a mixer shaft of the toner hopper 201, is vertical to a laser source beam; an upward line is drawn to form an included angle of 45 degrees from the perpendicular line; a forward-backward available space of the toner storage bin is a position limited by an overall width of 90 cm; wherein, a left translation is made by 45 cm from the upward line and a right translation is made by 45 cm from the upward line; and a left-right available space of the toner storage bin is an overall width of the cartridge.

In FIG. 5, the reference sign 215 means the printer laser beam, and the reference sign 216 represents a pair of translation lines at an interval of 90 cm, which is the width of the toner storage bins 202. The reference sign 220 means the aforementioned perpendicular line, and the reference sign 221 represents the aforementioned upward line with the included angle of 45 degrees.

The reference sign 217 means an inclination angle of toner storage bin 202, and the aforementioned perpendicular line 220 is set as the reference line. The value of the inclination angle of the toner storage bins 202 is in a certain range between 0 degree and 85 degrees, i.e. [0°, 85°].

In FIG. 5, a reference sign 218 denotes toners, and a reference sign 219 denotes waste toners (wastes).

The configurations described in the embodiments of FIG. 1 and FIG. 2, can be adopted by the first isolation mechanisms 205 and the second isolation mechanism 206 in the present embodiment.

In other embodiments, a waste guiding mechanism can also be provided in this two-wing-shaped continuous toner supplying cartridge 200; and similarly the configurations described in the embodiments of FIG. 1 and FIG. 2 can be adopted for the waste guiding mechanism in the same manner.

In some other embodiments, this two-wing-shaped continuous toner supplying cartridge 200 can also comprise at least two toner storage bins 202 and at least one waste storage bin 204, or adopt a design with at least one toner hopper 201 and at least two waste storage bins 204, so as to expand the toner capacity and the waste capacity of the whole two-wing-shaped continuous toner supplying cartridge 200.

On the other hand, this invention proposes an image forming device (image forming device adopting electrophotography such as a printer, a copying machine). It possesses the continuous toner supplying cartridge in any of the above-mentioned embodiments. As above described, when the continuous toner supplying cartridge proposed by the embodiments is adapted to the image forming device such as a printer, a copying machine, it is not necessary to modify the internal structure and boundary dimension of the image forming device such as a printer, a copying machine. An existing installation mode of the image forming device can be directly adopted.

To sum up, according to the technical features or a combination of the technical features mentioned in the embodiments, the continuous toner supplying cartridge proposed by this invention has the following significant advantages when compared with the prior art:

1) By assembling multiple toner storage bins and multiple waste storage bins in a single cartridge, a number of toner containers in the continuous toner supplying cartridge in the present invention is one or more times greater than a number of toner containers in the prior art, the capacity of toners in the present invention is one or more times larger than the capacity of toners in the prior art. Because a number of waste containers in the present invention is one or more times greater than a number of toner containers in the prior art, the capacity of wastes in the present invention is one or more times larger than the capacity of wastes in the prior art. Toners can be added manually or automatically by being replenished. Waste toners can be removed manually or automatically by being cleaned up. Such an improvement will lead to several times of printing amounts, fully utilize resources, and save users' usage costs.
2) The design of one or more waste storage bins for continuous toner supplying cartridge has fully considered the lifetime of photoconductor (OPC) drum. Generally speaking, the lifetime of photoconductor (OPC) drum can support about 10,000 pages, while the original toners in the existing cartridge can support printing 2,000-2,500 pages only. If the existing cartridge is directly discarded, resources will be seriously wasted and environmental pollution will be caused.
3) The design of one or more waste storage bins and one or more toner storage bins for continuous toner supplying cartridge can guarantee using toners with the same model and parameters in all toner storage bins. In this way, the printing quality can be ensured. However, in the existing compatible cartridges, later added toners often react with the residual original toners, which will reduce the printing quality and even result in toner leakage. These problems can be effectively resolved and removed via the continuous toner supplying cartridge proposed in this invention.
4) The continuous toner supplying cartridge invented this time has fully considered the inner space of printer, and it is not necessary to change the internal structure of printer. The continuous toner supplying cartridge invented this time can be directly installed and secured along the existing installation direction, and it is not necessary to change or modify other structures or components. Hence the cost can be saved and convenience will be provided in use.
5) The continuous toner supplying cartridge invented this time adopts the design of one or more waste storage bins. Moreover, a one-way opened isolation mechanism is provided between the original waste hopper and the waste storage bin. Users can dump wastes in the waste hopper into the waste storage bin(s) via a manual drive. In this way, normal printing can be guaranteed after toners are refilled.
6) The continuous toner supplying cartridge designed in this invention has fully considered the service life of photoconductor (OPC) drum and the design of toner storage bin(s). After toners in the whole toner storage bin and the toner hopper are used up, they can be replaced as a whole and it is not necessary to dump the wastes halfway in use.

While the present invention has been disclosed by way of the above-mentioned preferred embodiments, however it is not intended to limit the invention. It will be appreciated by those skilled in the art that various changes and modifications may be made therein without departing from the spirit and scope of the invention. Accordingly, the protection scope of the present invention is defined by the protection scope of the claims.

1. A continuous toner supplying cartridge, comprising a photoconductor drum, a wiper blade, a toner hopper and a waste hopper, wherein, the continuous toner supplying cartridge further comprising:
a toner storage bin, wherein, a first isolation mechanism is provided between the toner storage bin and the toner hopper; and,
a waste storage bin, wherein, a second isolation mechanism is provided between the waste storage bin and the waste hopper.

2. The continuous toner supplying cartridge as claimed in claim 1,
wherein the second isolation mechanism is configured as a one-way opening valve which can be opened under an external drive or a gravity action.

3. The continuous toner supplying cartridge as claimed in claim 1, wherein, a waste guiding mechanism is provided in the waste hopper for guiding waste toners in the waste hopper into the waste storage bin.

4. The continuous toner supplying cartridge as claimed in claim 3, wherein, the waste guiding mechanism is configured higher than an edge of the wiper blade, so that the waste toners can be guided to a position higher than the edge of the wiper blade.

5. The continuous toner supplying cartridge as claimed in claim 3, wherein, the photoconductor drum is configured as the waste guiding mechanism.

6. The continuous toner supplying cartridge as claimed in any of claim 1, wherein, the continuous toner supplying cartridge comprises at least two waste storage bins, and, further isolation mechanism, which can be one-way opened, is provided between the at least two waste storage bins.

7. The continuous toner supplying cartridge as claimed in claim 6, wherein, the further isolation mechanism is configured as a one-way valve, a plastic sheet or a metal sheet.

8. The continuous toner supplying cartridge as claimed in claim 1, wherein, the continuous toner supplying cartridge is configured as an n-shaped cartridge, and a connection port between the toner storage bin and the toner hopper is located in such a position that:
the connection port is located above and behind the n-shaped cartridge along a direction in which the n-shaped cartridge is loaded into a printer, at two outer sides of an included angle from both ends of a print width position, which is limited by the n-shaped cartridge, to a printer laser source of the printer.

9. The continuous toner supplying cartridge as claimed in claim 8, wherein an available space for the toner storage bin is located in such a position that:
a perpendicular line, which is from the photoconductor drum, is vertical to a printer laser source beam; and then a point is obtained by moving toward the printer laser source by 45 cm from the photoconductor drum along the printer laser source beam; an upward line is drawn from the point to form an included angle of 60 degrees from the printer laser source beam; a forward-backward available space of the toner storage bin is a position limited by an overall width of 90 cm, wherein, a left translation is made by 45 cm from the upward line, and a right translation is made by 45 cm from the upward line; and a left-right available space of the toner storage bin is an overall width of the cartridge; wherein, a horizontal line formed by the printer laser source and the photoconductor drum is set as a reference line.

10. The continuous toner supplying cartridge as claimed in claim 1, wherein, the continuous toner supplying cartridge is configured as a two-wing-shaped cartridge, and a connection port between the toner storage bin and the toner hopper is located in such a position that:
the connection port is located above and behind the two-wing-shaped cartridge along a direction in which the two-wing-shaped cartridge is loaded into the printer.

11. The continuous toner supplying cartridge as claimed in claim 10, wherein an available space for the toner storage bin is located in such a position that:
a perpendicular line, which is from a central point set as a mixer shaft of the toner hopper, is vertical to a laser source beam; an upward line is drawn to form an included angle of 45 degrees from the perpendicular line; a forward-backward available space of the toner storage bin is a position limited by an overall width of 90 cm; wherein, a left translation is made by 45 cm from the upward line and a right translation is made by 45 cm from the upward line; and a left-right available space of the toner storage bin is an overall width of the cartridge.

12. The continuous toner supplying cartridge as claimed in claim 1,
wherein, the continuous toner supplying cartridge comprises at least two waste storage bins, and a third isolation mechanism is provided between the at least two waste storage bins.

13. An image forming device, wherein comprising a continuous toner supplying cartridge as claimed in claim 1.
